(19) United States
(12) Patent Application Publication
(10) Pub. No.: US 2016/0075532 A1
(43) Pub. Date: Mar. 17, 2016

(54) Method And Device For Deforming A Profiled Shape Of A Material Web Into A Regularly Undulating And/Or Periodic Profile

(71) Applicant: Olaf RICHTER, Stein (DE)

(72) Inventor: Olaf RICHTER, Stein (DE)

(73) Assignee: Baumuller Anlagen-Systemtechnik GmbH & Co. KG

(21) Appl. No.: 14/410,750

(22) PCT Filed: Jun. 25, 2012
(86) PCT No.: PCT/EP2012/062241

§ 371 Date: Nov. 20, 2015

(51) Int. Cl. B65H 45/20; B31D 3/02

(52) U.S. Cl. CPC B65H 45/20; B31D 3/0246

(57) ABSTRACT

A method for transforming a profile form, in particular a longitudinal profile form of a material web in a regularly corrugated and/or periodic profile structure, wherein the material web comprises as material paper and/or plastic and/or plastic sheeting and/or heat-insulating material except for materials with metal/metallic and/or heat-conductive components, using one or more moving transforming means with which the material web is brought into positive engagement, wherein after the engagement of the transforming means the material web profiled as a consequence is brought in positive engagement with one or several adjustment means profiled in a complementary manner that are moved in such a manner relative to the transforming means that the profile structure formed by the transforming means is subjected for adjusting, changing or maintaining its accuracy to size to a possible subsequent fine adjustment and/or correction.

The invention relates to a method for transforming a profile form, in particular a longitudinal profile form of a material web or of a band material or of strips of material into a regularly corrugated and/or periodic profile. The material web comprises as material paper and/or plastic and/or plastic sheeting and/or heat-insulating material with the exclusion of materials with metal/metallic/ and/or heat-conductive components. Furthermore, paper embossed with phenol resin, including HPL sheets (HPL=High Pressure Laminates) or CPL sheets (CPL=Continuous Pressure Laminates) and Bakelite from the area of plastics can also be used in the scope of the invention.

The method is carried out using one or more moving transforming means with which the material web is brought in positive engagement.

Furthermore, the invention relates in particular to arrangements suitable for carrying out the cited method and for transforming the profile form of a material web into a regularly corrugated and/or periodic profile. A conveyor- or transport device is provided for the material web that comprises one or more moved or movable transforming means with which the material web is or can be positively engaged.

### BACKGROUND OF THE INVENTION

DE 195 45 038 A1 describes the manufacture of honeycombed plates. A material web is folded transversely to the direction of the web and the folded web is glued in a staggered manner on the top and the bottom. Thereafter, the upper and the lower edge of the material web are smoothed in the pressed state. Finally, the material web is uniformly stretched to the desired lengths. During the stretching of the material web the honeycombed patterns set by the glue lines are produced. However, no care is taken for the precise maintaining of a certain honeycomb pattern profile form.

In order to manufacture corrugated or ribbed heat exchanger lamellae it is known (U.S. Pat. No. 5,758,535) to run rolled metallic webs between toothed roller pairs imprinting a corrugated profile for forming the cooling ribs. A mechanical tension is produced in the metallic web at the beginning of the processing line by a pneumatic cylinder which tension is monitored in the framework of a control system with wire strain gauges and subsequently regulated by an appropriate control of the pneumatic cylinder. In the following processing stage corrugated profile is firmly compressed. The corrugated profile forming the ribs is automatically monitored in the compressed state regarding its average height that is optionally subsequently regulated. However, measures for maintaining a precise form of the imprinted corrugation profile or rib profile cannot be recognized.

A method for regulating the particular length of ribs and separated cooling lamella parts is also known (U.S. Pat. No. 5,207,083) in conjunction with the manufacture of corrugated or ribbed cooling lamellae from metallic webs for heat exchangers. A metallic web is run through a pair of shaping rollers and provided as a consequence with a corrugated profile. The pair of forming rollers is driven by a main drive controlled by a main control. During the further manufacturing process the corrugated metallic web is compressed and then stretched again with stretching rollers to a certain material density. To this end the stretching rollers are driven by a servodrive via a coupling to the main control synchronously in phase with the forming rollers. For the operation of a length control system the particular length of the cut-off cooling lamella parts is detected as the actual value. Upon a deviation from a theoretical value the speed of the servodrive for the stretching rollers is changed for a set time, wherein a phase shift of the servodrive and the stretching rollers relative to the main drive and the forming rollers results. This results in a change in the length and in the spacing of the ribs for the next cooling lamella part to be separated. The control and regulation for the servodrive of the stretching rollers contain a PI regulating algorithm in order to influence the length and the spacing of the ribs of the separated cooling lamella parts in the cited manner. However, since the total length of a separated cooling lamella part is measured as an actual value and is coupled into the control system, deviations from the maintaining of the specific profile form or profile shape are not detected. Certain inaccuracies in the shape and in the detailed course of the rib profile of the particular separated cooling lamella part are the consequence that, however, may not be damaging for applications as cooling exchangers and heat exchangers.

DE 10 2005 030 711 A1 describes the use of paper honeycombs in furniture. It is indicated for the manufacture of the paper honeycombs that a characteristic corrugation is embossed with the aid of toothed and heated double rollers.

### SUMMARY OF THE INVENTION

The invention has the basic problem of producing a corrugated or periodic profile form in a material web or a band material consisting of non-metallic and non-heat-conducting material whose desired shape structure is achieved or retained with optimized accuracy within the narrowest possible tolerances. Refer for the solution to the transforming methods indicated in claim 1 and to the transforming arrangements indicated in claims 10 and 17. Optional advantageous embodiments result from the dependent claims.

Accordingly, the transforming means is followed by adjustment means constructed for a positive engagement with the previously embossed profile structure of the material web. The positive engagement makes it possible for the adjustment means to engage into the profiled material web for the fine adjustment and/or correction of the profile structure in the sense of their accuracy to size, to actively shift, hold or accelerate it and to stretch, expand or compress it as a result. In particular, the periodic length of the profile structure can be changed, for example, upon a deviation from the given accuracy to size.

An optional embodiment of the invention also serves to change the periodic length, according to which the transforming means and the adjustment means are changed or shifted relative to one another in their particular location or position. It is advantageous in this connection that the transforming means and the adjustment means are synchronized in their movements using a common guiding axle, in particular a common theoretical position value. This latter is either generated virtually, for example, by run-up transmitters or derived from a real axle, for example, from the movements of the transforming means. An optional embodiment of the invention corresponds to this according to which the adjustment means is moved or activated synchronously with the transforming means, wherein a relative phase position or phase shift between the adjustment means and the transforming means is set or changed for the subsequent fine adjustment and/or correction of the profile structure for adjustment, change or the maintaining of their accuracy to size.

In order to set the relative phase position or the phase shift, the adjustment means (or also the transforming means) can be loaded with appropriate control data or control parameters that are entered, for example, manually, for example, even during the running operation of transformation. Alternatively or additionally, the setting or changing of the phase position or phase shift of the adjustment means (or also of the transforming means) can take place by regulating it as a function of a measuring of the profile periodic length or of other actual measurements of the formed profile structure. This opens the way to a further optional concept of the invention according to which the one setting or changing of the periodic length of the profile structure is realized as the actual value in the framework of a control system with the measured profile periodic length or an otherwise detected accuracy to size of the formed profile structure.

If adjustment means is moved or activated synchronously with the transforming means, then the spatial distance between the transforming means and the adjustment means can be set and adjusted for the subsequent fine adjustment and/or correction of the profile structure for the purpose of setting, changing or maintaining their accuracy to size—alternatively or additionally in combination with the above discussed method steps. This can take place, for example, by a manual inputting of the drive control data or drive control parameters serving for the distance setting, that correspond in particular to a desired influencing and changing of the profile structure. Alternatively or additionally, a regulation of the distance between the transforming means and the adjustment means can be carried out as a function of a measuring of the periodic length of the profile structure and/or of other actual measurements of the transformed profile for the accuracy to mass of the profile structure.

In order to increase the accuracy to size of the transformed profile structure, a rapid cooling off after the shaping is advantageous. To this end an optional embodiment of the invention provides the using of one or more cooling agents by means of which the profiled material web is put in a colder state after the using of the transformation means at a distance in time and space from the latter. This cooling, that stabilizes the profile structure formed, can be advantageously combined with a previous heating of the material web in order to further its ability to be transformed. A preheating can take place in a heating station arranged upstream from the transforming means in the direction of transport of the material web. Alternatively or additionally, the transforming means can be heated for the profiling contacting of the material web. The following cooling and stabilizing of the material web profile structure preferably takes place at the same time and place or at least largely at the same time and place with the engagement or use of the adjustment means.

A transforming arrangement suitable for carrying out the transforming method of the invention is distinguished in that one or more adjustment means profiled in a complementary manner follow the transforming means in the direction of conveyance or transport. This adjustment means is constructed to positively engage in the profiled material web. In order to maintain the predetermined accuracy to size, the transforming means is designed to be so adjustable that a subsequent fine adjustment and/or correction of the profile structure embossed or formed by the transforming means can take place.

Heating means serves to improve the ability to deform the material web and are arranged upstream from the transforming means and act on the material web or material strips present in the transporting to the transforming means. Alternatively or additionally, the heating means can have an active connection to the transforming means or be structurally integrated with them so that it is possible to directly heat them. Furthermore, one or more cooling elements or cooling components for cooling the material web already profiled by the transforming means are realized, preferably in combination with the heating means, and are arranged downstream from the transforming means. The cooling elements or cooling components can be separately constructed and have an active connection to the adjustment means. Another possible embodiment consists in that the cooling elements are structurally integrated with the adjustment means and that, for example, the adjustment means have a design as passive cooling bodies in addition to their actual adjusting function.

It is within the scope of the invention to realize the transforming means and/or adjustment means with a pair of forming wheels that oppose one another (roller pairs), that comprise on their outer circumference a cogging or shape corresponding to the profile to be embossed, bent or otherwise shaped. A passage slot or conveying slot for the material web is limited between them. In a further development of this arrangement that is specific for the invention and in which the forming wheel pairs are driven in synchrony with each other, a position offset/location offset or a phase shift is impressed on the adjustment forming wheels relative to the transforming wheels arranged upstream. The location offset and/or the phase shift serve to maintain the predetermined accuracy to size or a corresponding correction.

In the scope of the invention the forming wheel pairs are put in rotation with one or more separate drives. In order to achieve the accuracy to size of the profile structure it is advantageous to rotate the forming wheel pairs, in particular the adjustment forming wheels, in a regulated manner, for example, by servodrives in order to achieve a high precision of movement. If the forming wheel pairs or even the individual forming wheels are coupled to a separate drive (individual drive technology), they are preferably synchronized with each other via a commonly given guide value, for example, a theoretical position value. The guide value or theoretical position value is advantageously supplied via the appropriate theoretical value input of the particular (servo)drive. According to the invention a position offset or a phase shift is impressed on the drive or drives of the pair of adjustment forming wheels opposite the transforming wheel pair located upstream for the establishing, re-establishing or maintaining of the accuracy to size of the profile structure. The position offset or the phase shift can be given or adjusted on the one hand via an open control (open loop), for example, by a manually actuatable input medium or by other input interfaces. On the other hand, the position offset or phase offset (phase shift) to be impressed on the drives or servodrives of the pair of adjustment forming wheels can be derived from a control system with theoretical/actual value comparison and subsequently arranged control component. The actual value can be obtained from a measuring location for the periodic length or for other parameters of the accuracy to size of the transformed profile structure. It is advantageous, based on the invention, to monitor the maintaining or deviation from the predetermined accuracy to size of the profile by a measuring of the periodic length of the impressed profile structure. During the evaluation and processing of the measuring by the control system the cited measuring location is connected on the output side to the actual value input of a theoretical/actual value comparison component. This is followed by a control component, for example, PI (=Proportional-Interval) controller, for determining the position offset to be impressed or the phase shift to be impressed for the driver drives of the adjustment forming wheel pair.

As an alternative to, addition to or in combination with the formation of the invention (generation of a relative phase position or phase shift between the adjustment means and the transforming means for the fine adjustment and/or correction of the previously formed profile structure), the following is furthermore suggested for the solution of the initially cited problem of the invention in an arrangement for transforming the profile form of a material web with the initially cited features: The adjustment means profiled in a complementary manner and arranged downstream are provided with or connected to one or more linear drives. The latter are adjusted and designed in such a manner for adjusting the distance between the transforming means and the adjustment means that in order to maintain the predetermined accuracy to size any subsequent fine adjustment and/or correction of the profile structure formed by the transforming means takes place via a change of distance. Therefore, a compression or drawing apart or a compression or expansion of the profiled band material and with it a fine adjustment and/or correction of the periodic length or of other accuracy to size parameters of the embossed profile structure can be achieved as a function of the adjusted or varied distance of the transforming means and of the adjustment means.

### BRIEF DESCRIPTION OF DRAWINGS

Other details, features, combinations of features, advantages and effects based on the invention result from the following description of preferred exemplary embodiments of the invention and from the drawings. In the drawings:

FIG. 1 shows a block diagram of a manufacturing plant for honeycomb-structured, flat material with a transformation from band material to a honeycomb-like profile structure;

FIG. 2 shows a schematic functional view for the “preheating” module;

FIG. 3 shows a schematic functional view for the “transforming” module;

FIG. 4 shows a schematic functional view for the “cooling-down” module with a fine adjustment or correction of the profile structure;

FIG. 5 shows a schematic functional view for the “transverse cutter” module;

FIG. 6 shows a schematic functional view for the “side turner” module and the “strip welder” module;

FIG. 7 shows a detailed block diagram for the cooperation of the functional modules “transformation” and “cooling-down wheels” in the framework of an open control (open loop) serving for the accuracy to size of the profile structure;

FIG. 8 shows a detailed block diagram for the cooperation of the functional modules “transformation” and “cooling-down wheels” in the framework of a control system (closed loop) serving for the accuracy to size of the profile structure.

### DETAILED DESCRIPTION

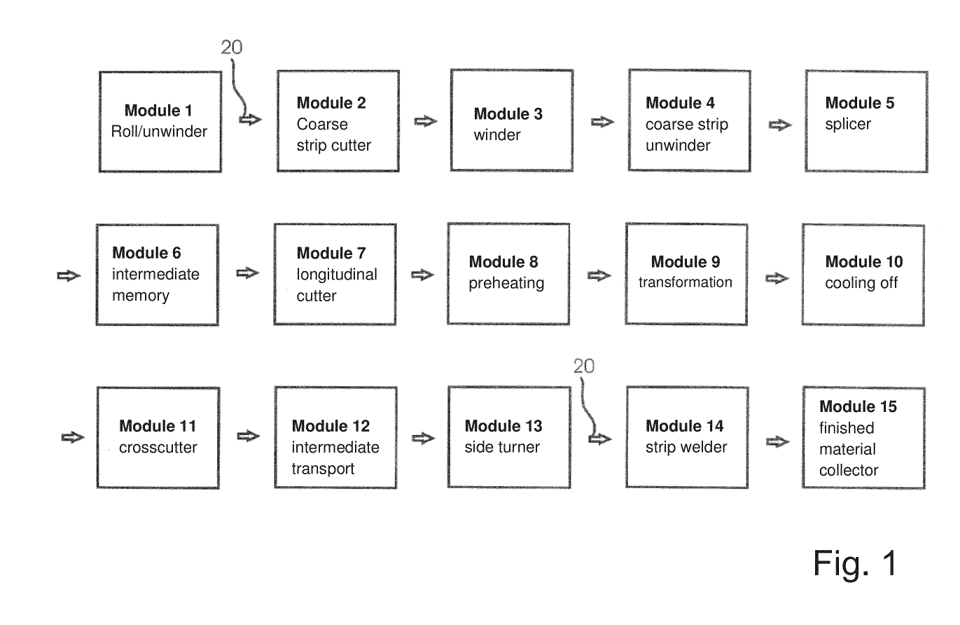

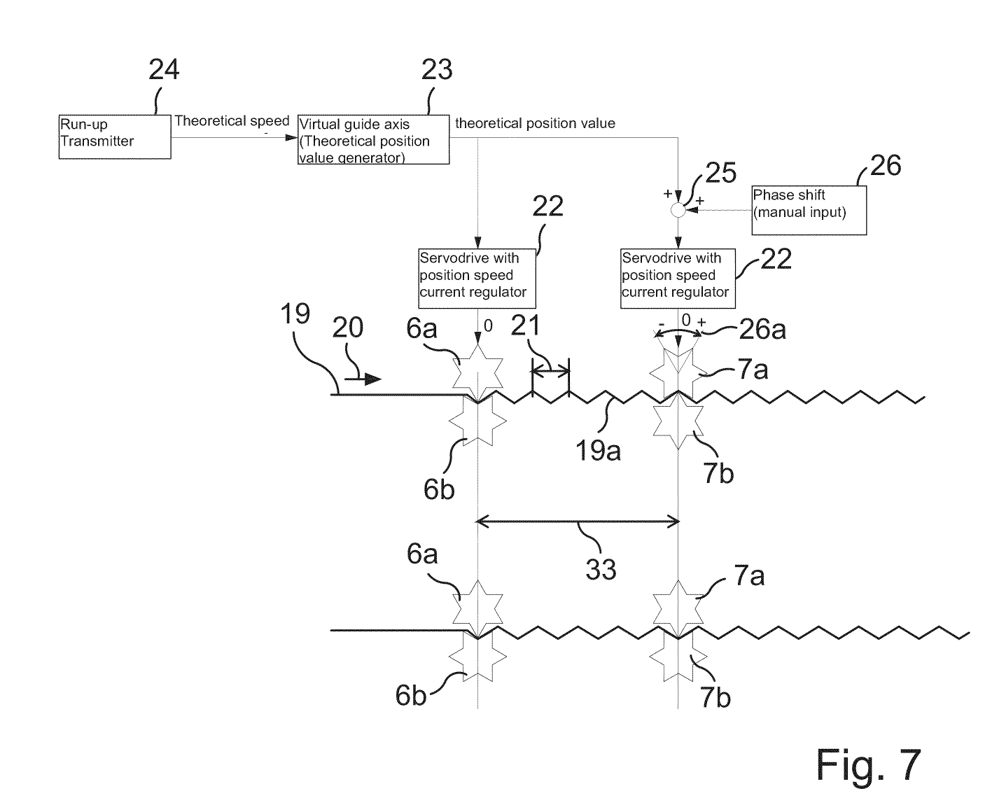

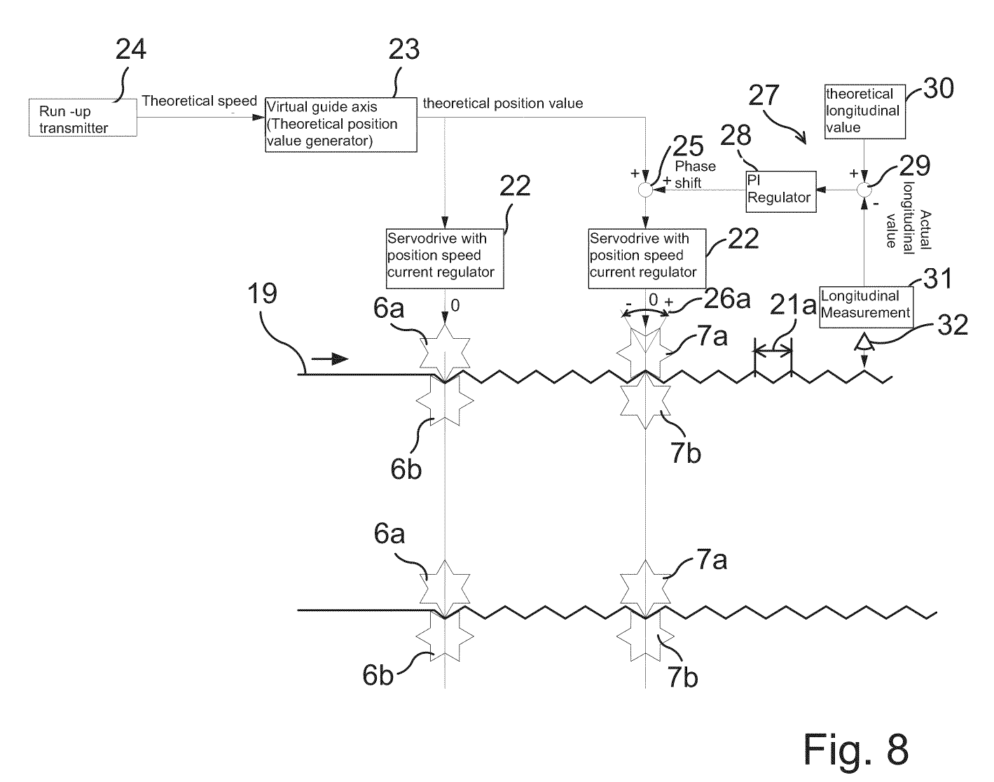

According to FIG. 1 an exemplary manufacturing process runs through the manufacturing stations or steps cited as modules one to fifteen, wherein the modules nine “transformation” and ten “cooling-down wheels” make use of the invention (see the description, in particular in combination with FIGS. 7 and 8). In module four, “coarse strip unwinder”, a rolling off from coarse strip rolls with paper takes place. Two paper rolls are used in order to ensure an endless operation. The second roll is held in reserve until the paper material of the first roll has been used up. In module five, “splicer”, a welding of the end area of one roll to the initial area of the next roll takes place. This is brought about with the aid of an electromagnetically driven welding stamp, wherein an optical sensory device is also used for checking the presence of paper strips. In module six, “intermediate memory” the time of the splicing procedure (interruption of the supply of material) is compensated by an intermediate memory in order to ensure a continuous manufacturing operation. To this end paper strip rolls are held ready on a movable carrier. After the completion of the splicing procedure the memory is to be filled again. In module seven, “longitudinal cutter”, a certain number of individual strips are produced from the supplied coarse paper strips (e.g., 80 mm-wide coarse strips in four individual strips each 20 mm wide).

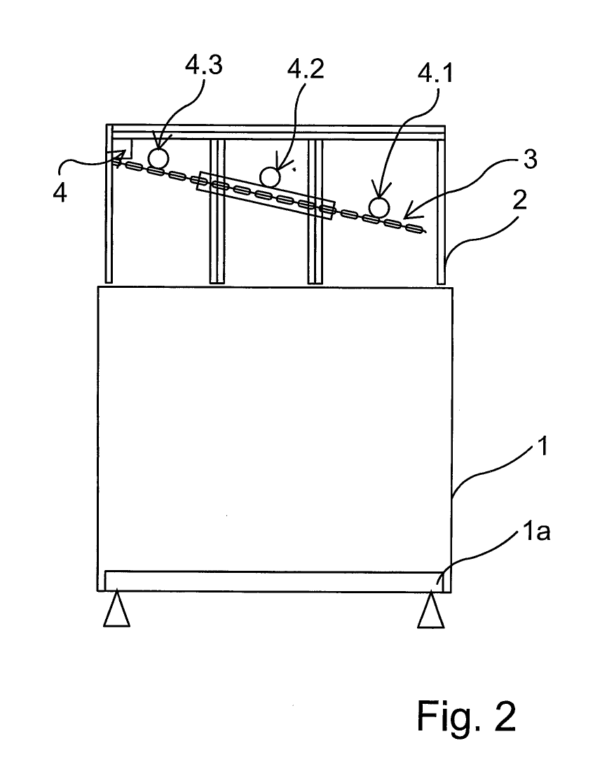

According to FIG. 2 the module eight, preheating”, comprises an undercarriage 1 of sheeting and a steel frame. A multi-stage heating device 2 with resistor heating elements 3 of, for example, 300 watts each is mounted on the undercarriage. Several temperature sensors 4.1-4.4 are arranged inside the heating device 2, preferably with each one associated with a stage. Among these sensors one infrared temperature sensor 4.4 is placed in the end area of the heating device 2. The supplied material web, for example, paper strips, can be preheated in several stages to temperatures adjustable by the sensors 4.1-4-4 by this preheating module, which facilitates the following transformation.

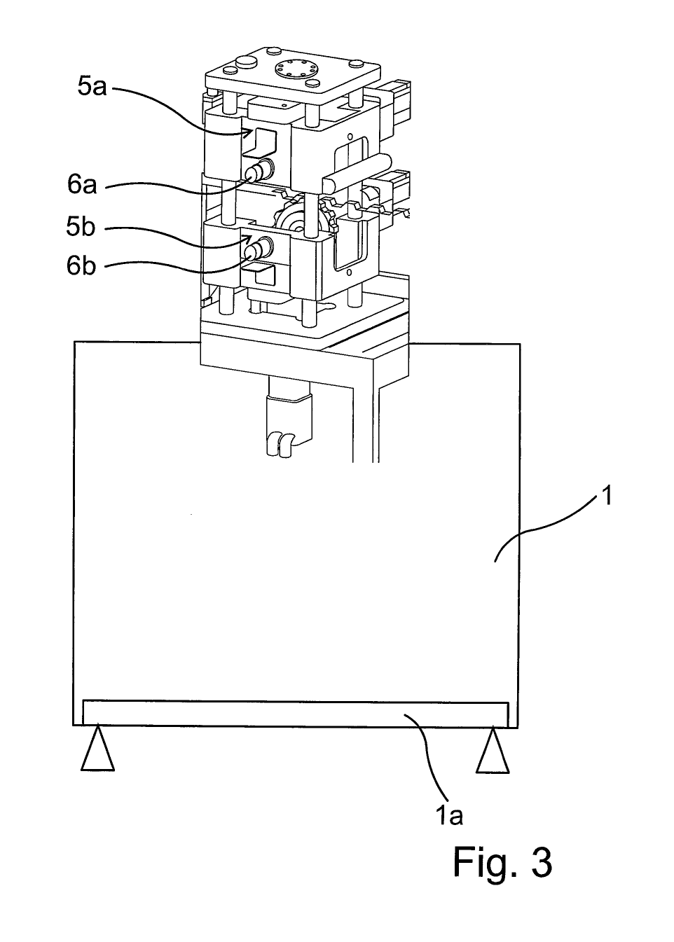

In the module nine, “transformation”, according to FIG. 3 a drive unit 5 is present on the undercarriage 1, which drive unit comprises several drives, in particular drives 5a, 5b, each associated with a transforming wheel. In the illustrative representation the transforming wheels 6a, 6b are marked only by their visible projecting shaft stumps or axle stumps. The corrugated profile structure of the paper strips is produced with them. To this end the particular outside circumference of the transforming wheels 6a, 6b is designed with a cogged structure corresponding to the desired profile structure. The transforming wheels 6a, 6b are separately heated for better deformability. The transforming takes place under the loading of a previously defined pressure (contact pressure), wherein the exposure time and the temperature are also relevant for the quality of the material web. The cited process parameters are to be adjusted as a function of the particular selection of material.

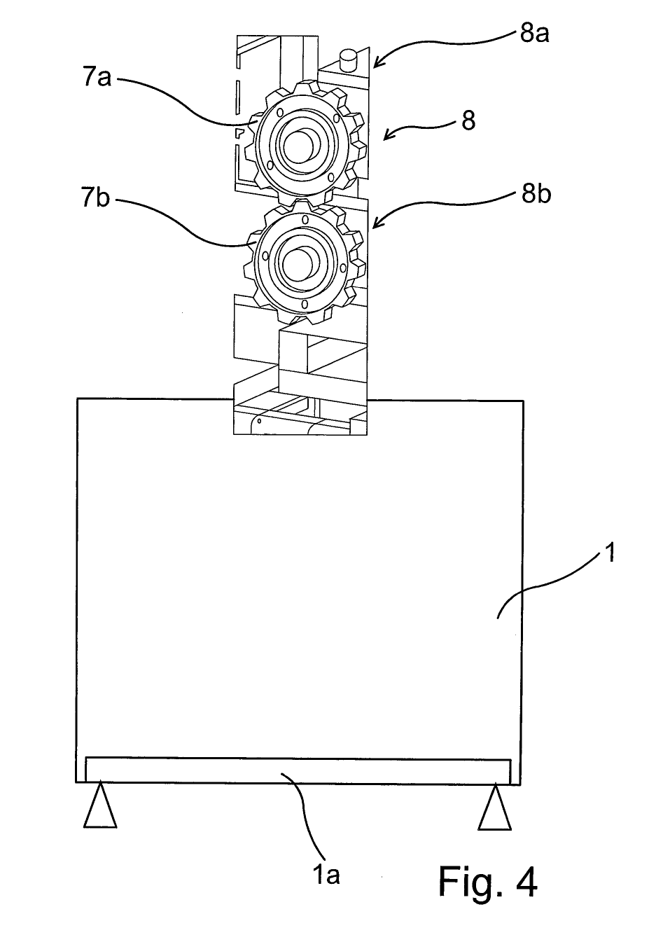

In the module ten, “cooling-off”, according to FIG. 4 a drive unit 8 supporting two cooling transforming wheels 7a, 7b is present on the undercarriage 1, which drive unit comprises drives 8a, 8b, each associated with one of the cooling transforming wheels 7a, 7b. As is indicated in FIG. 4, the cooling transforming wheels 7a, 7b are also provided on the outside circumference with a cogging structure corresponding to that of the transforming wheels 6a, 6b arranged upstream, so that a positive engagement into the profile structure is made possible in a complementary manner for the cooling transforming wheels 7a, 7b, which profile structure was formed by the transforming wheels 6a, 6b arranged upstream. This stabilizes and increases the accuracy to size. The cooling action also contributes to this, that is passively exerted based on the mass and the preferably heat-conductive material (for example, metallic) of the (unheated) cooling transforming wheels 7a, 7b. In order to make possible their positive engagement into the already-formed profile structure of the transported material band, the cooling transforming wheels 7a, 7b are driven synchronously with the transforming wheels 6a, 6b (see below). If the cooling transforming wheels 7a, 7b are staggered in their phase relative to the transforming wheels 6a, 6b, a compression or expansion of the worked material band in its length and also in its profile structure, in particular in its periodic length, can be brought about.

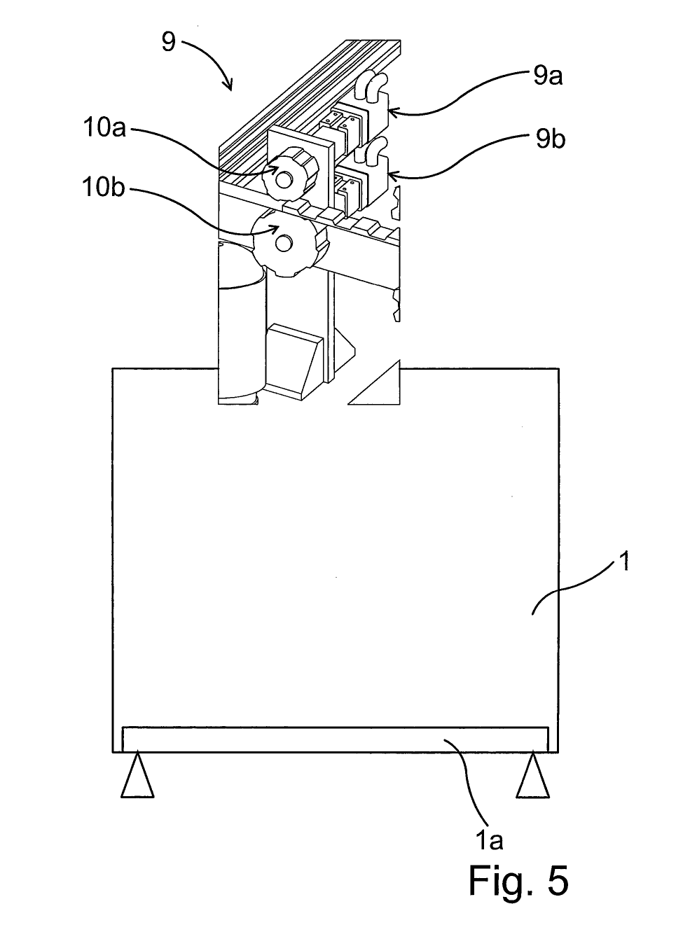

In module eleven, transverse cutter”, according to FIG. 5 another drive unit 9 is mounted on the undercarriage 1 into which at least two drives, a drive 9a for a cutting wheel 10a, and drive 9b for an opposite counter-holder forming wheel 10b are received. As indicated in FIG. 1, the module “transverse cutter” is arranged in the direction of transport of the material band 20 after the modules nine “transforming” and ten “cooling-down”. The subsequent fine adjusting or correction of the profile structure formed by the transforming wheels 6a, 6b by the cooling forming wheels 7a, 7b takes place in the sense of maintaining the accuracy to size, therefore before the transverse cutting or cutting to length of the strips to a previously defined length according to FIGS. 1, 5.

In the module twelve, “intermediate transport”, the cut-to-length strips are transported into a subsequent side turner. To this end a conveyor belt is used in whose area preferably several, e.g., four optical sensors are arranged for the controlling of the honeycomb strips.

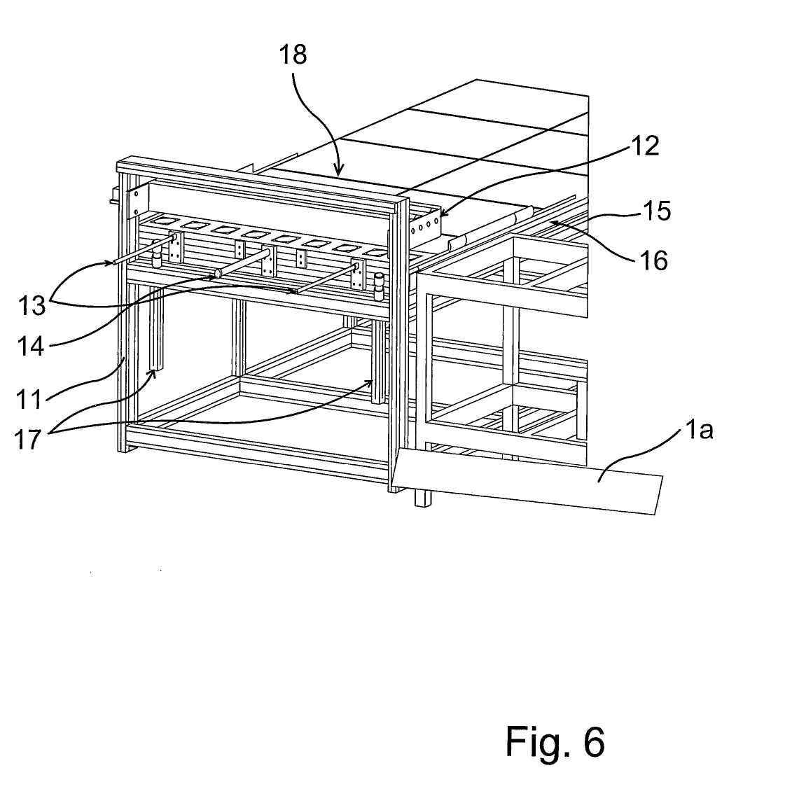

In the modules thirteen, “side turner”, and fourteen, “strip welder”, according to FIG. 6 a drive unit for, for example, honeycomb strip turners with appropriate drives in addition to guides 13 and a drive 14 for pushers is arranged on a frame 11. A position control device 16 is associated with a table plate 15 also set on the frame 11 in order to control the state of the table plate. Furthermore, the table plate 15 has an active connection to means and drive 17 for raising and lowering. As soon as the cut-to-length, corrugated, profiled paper strip passes into the side turner, it is rotated through 90°, the strip falls (“lying on its side”) onto the honeycomb table/welding table (table plate 15). A pusher positions the strips so that they are welded to a flat structure by the strip welder coming from below. The pusher transports the honeycomb further so that the next strips can be welded onto the present structure. The process parameters of pressure, active time and temperature are decisive for the quality of the honeycombs and dependent on the material process.

According to FIG. 7 a material band 19 that still has a smooth and level longitudinal profile is transported in transport direction 20 into the slot of a roller pair formed by the two opposing, cogged transforming wheels 6a, 6b. After the transformation in a roller slot the material band 19 is provided with a profile structure running in sawtooth-like corrugations and with the periodic length 21. In order to stabilize the achieved longitudinal profile form, the material band 19a, which is now corrugated, is fed to the slot of a second roller pair formed from the two opposing cooling form wheels 7a, 7b. Each of the two forming wheel pairs is moved and controlled by a servodrive 22 that is provided, as is known, in a standard manner with a position-, speed- and current control for the particular electrical drive motor. Each of the forming wheels 6a, 6b, 7a, 7b is associated in the sense of a direct or individual drive technology with its own electromotor for the rotary drive. Alternatively, the forming wheels of each roller pair 6a, 6b and 7a, 7b can be driven via mechanical couplings by a common electromotor. In order to achieve a synchronism or synchronous course between the two roller pairs 6a, 6b and 7a, 7b and/or between the transforming wheels 6a, 6b of the module nine and the cooling forming wheels 7a, 7b of the module ten for transforming or cooling, a common, virtual guiding axle is set for the servodrives 22 associated with the two roller pairs 6a, 6b and 7a, 7b. This axle is realized with a theoretical position value generator 23 that is guided by a run-up transmitter 24 in that the latter outputs a theoretical speed on the theoretical position value generator 23. Therefore, the cooling forming wheels 7a, 7b can run synchronously with the transforming wheels 6a, 6b. The output of the theoretical position value generator 23 is directly supplied to the input of the servodrive determined for the transforming roller pair 6a, 6b. At the input of the servodrive determined for the cooling forming roller pair 7a, 7b a phase shift (offset) 26a between the particular zero position of the transforming wheels 6a, 6b and the cooling forming wheels 7a, 7b is also superposed on the output of the theoretical position value generator 23. This can be achieved, for example, by a summing element 25 to whose first input the theoretical position value is supplied and to the second value the date or signal for the phase shift 26a is supplied from an input medium 26. As a result of the superpositioning of the phase shift on the theoretical position value input of the servodrive a phase offset or a lag or lead in comparison to the transforming wheels 6a, 6b is put on the cooling forming wheels 7a, 7b, as indicated in FIG. 7 by the positive and negative phase offset relative to the zero position. This results in a compression or expansion of the profile structure impressed by the transforming wheels, in particular of the periodic length 21. This correction or post-adjustment of the periodic length 21 and of the accuracy to size by compression or expansion advantageously takes place in the manufacturing section between the transforming roller pair 6a, 6b and the cooling forming roller pair 7a, 7b, where the material band 19 with its profile can still be shaped on account of the cooling-off which has not yet taken place (completely or perceptibly). The compression- or expansion process that can therefore still be readily achieved) can be decisive for the accuracy to size of the profile structure. The positive engagement of the cooling forming wheels 7a, 7b into the profile structure shaped by the transforming wheels 6a, 6b contributes to the compression or expansion in the sense of a fine adjustment or correction for the conveying or maintaining the accuracy to size. This compression or explosion and, associated with it, the fine adjusting of the periodic length 21 of the profile structure can be influenced not only by the relative position of the angle between the transforming wheels and the cooling forming wheels but also by the distance of the two roller pairs 6a, 6b and 7a, 7b from each other. For example, the distance is several periodic lengths 21, in the example shown more than five periodic lengths. The input medium 26 for the superpositioning of the phase shift can be manually actuated or controlled by an external product management software.

The lower part of FIG. 7 shows by way of a comparative clarification a synchronized angle position of the transforming wheels and of the cooling forming wheels to each other without offset. The particular angle position of the forming wheels of the two roller pairs 6a, 6b and 7a, 7b is identical.

In distinction to FIG. 7, in the exemplary embodiment according to FIG. 8 the phase shift is generated by a closed control system 27 comprising a PI regulator 28 whose output is supplied to the summing element 25 with a positive sign (as in the case of the input medium according to FIG. 7). The regulator input is connected to the output of a theoretical-/actual value comparison element 29. A theoretical value for the accuracy to size of the profile structure is supplied to the first, positive input of the comparison element 29 from the output of a generator 30 for the accuracy to size of the profile structure, which theoretical value is determined or can be determined by a manual input or by product management software analogously to the input medium according to FIG. 7. For example, the theoretical value consist of a date or signal or other value for a theoretical periodic length for the profile structure to be impressed. The second, negative input of the comparison element 29 is connected to the output of a measuring point 31 for the actual value of the periodic length 21a of the profile structure that occurs after the cooling and forming roller pair. The measuring point 31 comprises a sensor 32 that scans the profile structure, in particular periodic length 21a of the transformed material band 19. The phase shift can be regulated via the control system 27 and therefore the quality, for example, of the paper strips to be transformed for a honeycomb structure can be decisively influenced in that the actual accuracy to size of the impressed profile structure is detected by this sensor 32 and the appropriate measuring point 31. If a deviation of the actual periodic length 21a from the theoretical periodic length is determined by the comparison element 29 the PI regulator generates a corresponding phase shaft 26a for the location position and rotary position of the cooling forming wheels 7a, 7b relative to the transformation wheels 6a, 6b from the inputted regulating difference. As a result, the deviation from the theoretical accuracy to size and the theoretical periodic length of the profile structure can be regulated via the expansion or compression resulting from the phase shift.

### LIST OF REFERENCE NUMERALS

1 undercarriage
1a cable conduit
2 heating device
3 resistor heating element
4.1-4.4.1 temperature sensors
5 transforming wheel drive unit
5a, 5b drives
6a, 6b transforming wheel
7a, 7b cooling forming wheel
8 cooling forming wheel drive unit
8a, 8b cooling forming wheel drive
9 drive unit of the crosscutter
9a cutting wheel drive
9b counter-holder forming wheel drive
10a knife-/cutting wheel
10b counter-holder forming wheel
11 frame
12 drive unit of the honeycomb strip turner
13 pusher guides
14 pusher drive
15 table plate
16 table plate position control
17 table plate lifting and lowering means
18 honeycomb strip—magnetic pin stopper
19 material web
19a profiled material web
20 direction of transport
21, 21a periodic length
22 servodrive
23 theoretical position generator
24 run-up transmitter
25 summing element
26 input medium for phase shift
26a phase shift
27 control system
28 PI regulator
29 comparison element
30 generator for the accuracy to size of the profile structure
31 measuring point for the actual value of the periodic length
32 sensor
33 distance

1. A method for transforming a longitudinal profile form of a material web (19) into a regularly corrugated or periodic profile structure, wherein the material web (19) comprises as material paper and/or plastic and/or plastic sheeting or heat-insulating material except for materials with metal/metallic or heat-conductive components, using one or more moving transforming means (6a, 6b) with which the material web (19) is brought into positive engagement, characterized in that after the engagement with the transforming means, the material web (19a) which was profiled as a consequence is brought into positive engagement with one or several adjustment means (7a, 7b), profiled in a complementary manner, that are moved in such a manner relative to the transforming means (6a, 6b) that the profile structure formed by the transforming means (6a, 6b) is subjected, for adjusting, changing or maintaining its accuracy to size, to a subsequent fine adjustment or correction.

2. The method according to claim 1, characterized in that for the fine adjustment or correction, the transforming means and the adjustment means (6a, 6b; 7a, 7b) are moved or shifted relative to each other in their particular position.

3. The method according to claim 2, characterized in that, for the fine adjustment or correction, the profiled material web (19a) is stretched, compressed or expanded by the adjustment means (7a, 7b) or the periodic length (21) of the profile structure is changed.

4. The method according to claim 3, characterized in that the adjustment means (7a, 7b) are moved or activated synchronously with the transforming means (6a, 6b), wherein, for a subsequent fine adjustment or correction of the profile structure for the purpose of setting, changing or maintaining its accuracy to size, a relative phase position or a phase shift between the adjustment means (7a, 7b) and the transforming means (6a, 6b) is set or changed.

5. The method according to claim 4, characterized in that the setting or changing of the phase position or phase shift of the adjustment means (7a, 7b) comprises their control via an input medium (26) for a phase shift (26a).

6. The method according to claim 5, characterized in that the setting or changing of the phase position or phase shift of the adjustment means takes place by regulating (27) them as a function of a measuring (31) of the periodic length (21a) of the profile or of other actual dimensions of the formed profile structure.

7. The method according to claim 6, characterized in that the adjustment means (7a, 7b) is moved or activated synchronously with the transforming means (6a, 6b), wherein, for a subsequent fine adjustment and/or correction of the profile structure for the purpose of setting, changing or maintaining its accuracy to size, the spatial distance between the transforming means (6a, 6b) and the adjustment means (7a, 7b) is set or changed by a manual inputting of corresponding control data or control parameters or by regulating the distance as a function of a measuring (31) of the periodic length (21a) of the profile structure or of other actual dimensions of the formed profile.

8. The method according to claim 7, characterized by the use of one or more cooling agents by means of which the profiled material web (19a) is put in a colder state, after the use of the transforming means, at a distance in time and place from the transforming means.

9. The method according to claim 8, characterized in that the use of cooling agent takes place at the same time and place as engagement of the adjustment means.

10. An arrangement for transforming the profile form of a material web (19) into a regularly corrugated or periodic profile structure, which material web (19) comprises, as material, paper or plastic and/or plastic sheeting or heat-insulating material except for materials with metal/metallic and/or heat-conductive components, with a conveyor device or transport device provided for the material web which device comprises one or more moved or movable transforming means (6a, 6b) with which the material web (19) is or can be put in positive engagement, characterized in that one or more adjustment means (7a, 7b), profiled in a complementary manner for the positive engagement in the profiled material web (19a), are arranged downstream from the transforming means (6a, 6b) in a direction of conveyance or transport (20), which adjustment means is moved or can be moved in such a manner relative to the transforming means (6a, 6b) that, in order to maintain a predetermined accuracy to size, a possible subsequent fine adjustment or correction of the profile structure formed by the transforming means (6a, 6b) takes place.

11. The arrangement according to claim 10, characterized in that the transforming means (6a, 6b) is provided with or has an active connection with heating means for heating the material web (19) or the adjustment means (7a, 7b) is provided with or has an active connection with one or more cooling elements for cooling the material web (19a) profiled by the transforming means.

12. The arrangement according to claim 11, characterized in that a cooling element comprises a passive cooling body.

13. The arrangement according to claim 12, wherein the transforming means or adjustment means (6a, 6b; 7a, 7b) are implemented with a pair of opposing forming wheels that comprise on their outer circumference a cogging or shape corresponding to the profile structure to be embossed, bent or otherwise shaped, and form a passage- and conveying slot for the material web (19, 19a) between themselves, characterized in that the forming wheel pairs (6a, 6b; 7a, 7b) can be driven or are driven in synchrony with each other, wherein a position offset or a phase shift (26a) for maintaining the predetermined accuracy to size of the profile structure can be impressed or is impressed on adjustment forming wheels (7a, 7b) relative to transforming wheels (6a, 6b) arranged upstream.

14. The arrangement according to claim 13, characterized in that forming wheel pairs (6a, 6b; 7a, 7b) can rotate in a preferably regulated manner with one or more separate drives (22), and that the drives (22) are synchronized or can be synchronized with each other via a theoretical position value (23) given in common, wherein a predetermined position offset or a predetermined phase shift (26a) opposite a transforming wheel pair (6a, 6b) located upstream is impressed or can be impressed on the drive or drives (22) of the adjustment forming wheel pair (7a, 7b).

15. The arrangement according to claim 13, characterized in that the forming wheel pairs (6a, 6b; 7a, 7b) can rotate in a regulated manner with one or more separate drives (22), and that the drives (22) are synchronized or can be synchronized with each other via a theoretical position value (23) given in common, wherein a position shift or phase shift (26a) opposite the transforming wheel pair (6a, 6b) located upstream is impressed or can be impressed on the drive or drives (22) of the adjustment forming wheel pair (7a, 7b) according to a measuring value or actual value from a measuring point (31) for the periodic length (21a), or for the accuracy to size of the formed profile structure.

16. The arrangement according to claim 15, characterized in that the measuring point (31) is connected or can be connected on an output side to an actual value input of a control system (27) for determining the position offset or the phase shift (26a), to be impressed for the drive or the drives (22) of the adjustment forming wheel pair (7a, 7b).

17. An arrangement for transforming the profile form of a material web (19) into a regularly corrugated or periodic profile, wherein the material web (19) comprises as material paper or plastic or plastic sheeting or heat-insulating material with the exclusion of materials with metal/metallic/ or heat-conductive components, with a conveyor or transport device provided for the material web that comprises one or more moved or movable transforming means (6a, 6b) with which the material web (19) is or can be positively engaged, characterized in that one or more adjustment means (7a, 7b), profiled in a complementary manner, follow the transforming means (6a, 6b) in a direction of conveyance or transport (20) for a positive engagement into the profiled material web, whereby the transforming means or adjustment means (6a, 6b; 7a, 7b) are provided with or connected to one or more linear drives that are set up or constructed for adjusting the distance (33) between the transforming means and the adjustment means in such a manner that, in order to maintain a predetermined accuracy to size during a change of distance, a subsequent fine adjustment or correction of the profile formed by the transforming means (6a, 6b) takes place.
